(19) United States
(12) Patent Application Publication
(10) Pub. No.: US 2011/0081196 A1
(43) Pub. Date: Apr. 7, 2011

(54) Space Frame Connection Members

(76) Inventor: Nezih Aysan, Istanbul (TR)

(21) Appl. No.: 12/922,272

(22) PCT Filed: Mar. 27, 2009
(86) PCT No.: PCT/TR09/00044

§ 371 Date: Dec. 8, 2010

(30) Foreign Application Priority Data
Mar. 31, 2008 (TR) 2008/02137

(51) Int. Cl. F16B 7/18

(52) U.S. Cl. 403/300

(57) ABSTRACT

It will be clearly seen that the bolt-like piece (1) described in the space frame connection system is embossed on the shaft with the part with thread being excluded, and the groove-set is formed, and as a result of title assembly of these two parts with groove-set formed in the hole section inside the wide nut-like piece (3) within the tolerances and at the same pitch (FIG. 4/2, FIG. 4/3), the system has the strength against the serious values of excessive pressures.

This invention, as seen in FIG. 4/4, relates to not performing any physical modification that will decrease the load that may be borne by the bolt in its yield strength on the bolt shaft (1) utilized for the space frame connections.

Owing to the hole (6) with a minimum size made perpendicularly to the section without thread on the shaft of the bolts used in the known roof connection systems, a channel is opened wider than the hole made on the bolt, through which the cylindrical shaft piece passed through the hole made on the bolt (1) may comfortably pass in a substantial portion of the surface area of the nut on two corresponding faces (7) of the hexagonal surfaces of the nut-like piece (3) with a wide size fitted comfortably onto said bolt without any excessive gap, said wide and nut-like piece (3) being fitted on the bolt (1).

The channels on the opposite surfaces of the fixed wide part similar to the nut are brought into the same alignment with the hole on the bolt and are hammered along the full length with such tightness as to prevent the spindle part, having the size corresponding to the wrench opening measure of the nut-like piece (6), from dropping from the hole in the bolt.

This cylindrical spindle assists in the tightening and loosening of the bolt (1) and hexagonal wide nut (3) to rotate these together in the required direction.

Since the cylindrical spindle part, which passes through the hole drilled on the bolt when it is rotated with the help of the wide hexagonal piece (3) on the bolt during assembly, is forced to cut, its torque values become very low, this hole made on the bolt shaft renders the production difficult and thus significantly decreases the strength of the bolt.

The reason for use without drilling a hole in the region of the bolt (1) shaft with no thread is that it is more durable.

Connection members can be seen from the attached figures.

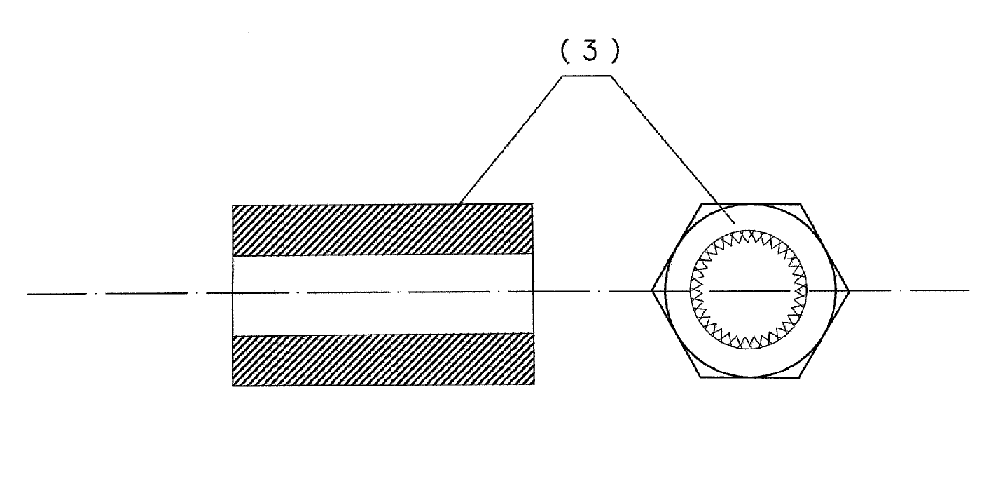

FIG. 1—Bolt used for connection

FIG. 2—Conical part used for connection

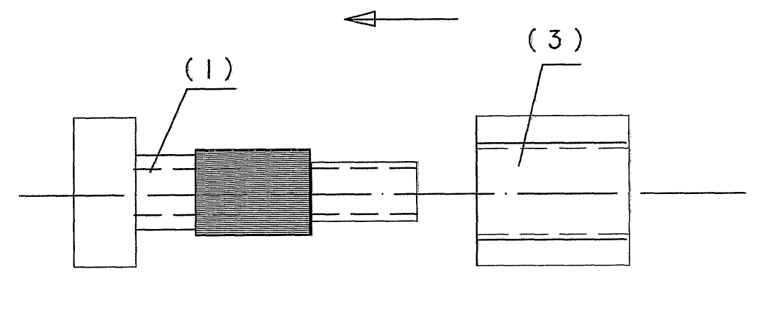

FIG. 3—Wide nut-like piece used for connection

FIG. 4—Sphere used for connection

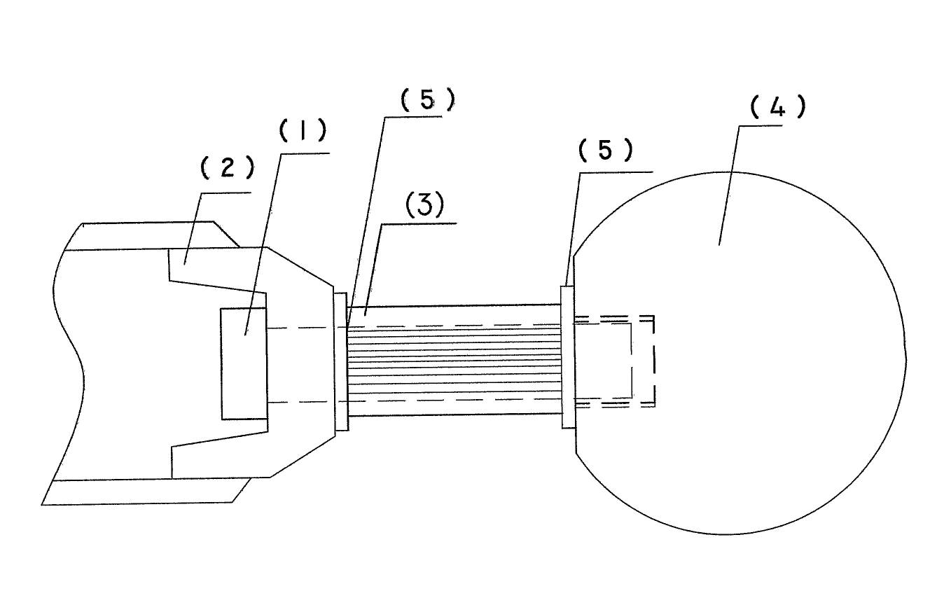

FIG. 5—Gasket used for connection

FIG. 6—Cylindrical spindle passing through the hole opened in the bolt shaft

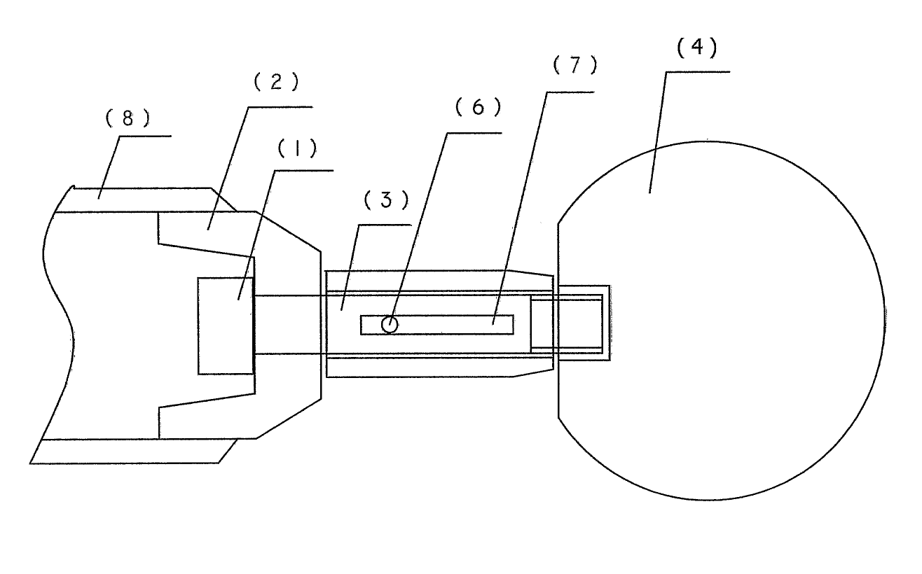

FIG. 7—Channel opened on the facing surfaces of the wide nut-like piece

FIG. 8—Pipe welded to the conical part

As can be seen from FIG. 4/2, in order to achieve the object of the invention, the strength of the parts is in a maximum level, since no physical shaping process is applied on the parts like the bolt (1) and the wide nut-like piece (3) that would weaken and corrode the same.

Besides, since the parts (1), (3), (4) used in the system (FIG. 4/3) will be used in smaller sizes, the system will become lighter, thereby reducing the costs.

As a result of assembly by joining of the mechanical parts (1), (2), (3), (4) shown in (FIG. 4/3), it will be seen that when the wide nut-like piece (3) fitted on the bolt (1) is rotated (tightened), it carries the standard torque sizes. As a result of the groove-set application made by means of the denting and embossing (rubbing) method on the part of the shaft past the thread made on the end section of the bolt (1), the conical piece (2) to be assembled onto the bolt shaft is engaged by its middle portion until it touches the head section of the bolt (1). The piece (3) has a hexagonal outer surface, and the inner hole section is applied to the shaft of the bolt (1) having the opened groove-set in a sliding mariner but within the tolerances that will avoid its fall by its own weight, by way of lifting the metal filings to the corresponding nut piece with a wide thread (3) through a machine apparatus made of hard metal called brooch-needle, hence the groove-set is formed in the hole of the hexagonal piece (3).

When a pitch is opened with size compatible with the bolt (1) on the part (4) for the parts (1), (2), (3) of the hexagonal wide nut piece (3), it will be possible to tighten the piece (3) with the help of a wrench in hi torque limits without any problem.

According to the current way of use for the space frame connection members, as can be seen in (FIG. 4/4), the cylindrical spindle tightly passes through the hole (6) made hi the direction of the cross-section of the bolt (1), and it may be tightened by rotating along with the wide hexagonal nut piece (3) by means of the spindle part nailed into the hole on the bolt, with the channels (7) opened on the opposite surfaces of the wide nut.

This tightened bolt (1) and the wide nut piece (3) are limited by the strength of cylindrical spindle part that passes through the hole (6) on the bolt. Here, the hole (6) where the spindle is hammered on the bolt shaft (1) seriously weakens the physical properties oldie bolt (1).

As a result of tensile tests to be performed, it will break away in a value significantly lower than the standards, and the break away section will be break but this hole drilled on the bolt shaft (1).

It is time to time observed that the wide nut piece (3) remaining between the sphere (4) on node points and the conical part (2) after assembly of the space frame connections becomes subject to pressure and thus deformed at some points.

The deformation of this part (3) (FIG. 4/4) will cause the system size to be negatively affected.

The object of the invention is to provide that the bolt (1) and the wide nut-like piece (3) utilized for space frame connection members provide ease of use (FIG. 4/2) without any negative physical change and without any change in the strength standards, and the convenience is provided in the production and the costs are lowered.

Besides, among the bolts (1) used without any hole being drilled on the shafts thereof and the wide nut-like pieces (3) without any channel being opened thereon (FIG. 4/2) and the spheres at the node points, the ones will be preferred that is at least one grade thinner or smaller in size, in the design stage. This preference will lead to a reduction in the production costs and a lightening of the overall frame system.

On the other hand, there will also be cost advantages besides the lightness of the space frame systems with II, III floors designed up to a certain static calculation limit. According to another aspect, it will be possible to cover the wide openings in larger distances, without placing poles (supports).

Consequently, the opportunity has been obtained to cover with roof the wider areas with higher strength, light weight, longer distance between the poles (supports) and at lower costs.

1- Space frame system connection member characterized in that the groove-set is formed according to the embossing method in the part of the shaft of the bolt (1) used in the system, without a thread.

2- Space frame system connection member according to claim 1 characterized in that it comprises a piece with increased strength, which is like a wide nut with hexagonal shape corresponding to the embossed groove-set, and is fitted on the shaft of said bolt (1).

3- 2 pieces of gaskets (5) in the space frame connection systems characterized in that the two pieces of gaskets (5) are compressed upon the wide nut piece (3), which is engaged on the bolt (1) between the conical piece (2) and the spherical piece (4), contacting on two side surfaces thereof, and there is no hole on the wide nut and thus, the bolt that remains hidden inside is not subject to damage caused by the external factors.
